(19) United States
(12) Patent Application Publication
(10) Pub. No.: US 2024/0359928 A1
(43) Pub. Date: Oct. 31, 2024

(54) Transfer Device

(71) Applicant: LG Energy Solution, Ltd., Seoul (KR)

(72) Inventor: Seung Hyun Ji, Daejeon (KR)

(73) Assignee: LG Energy Solution, Ltd., Seoul (KR)

(21) Appl. No.: 18/580,978

(22) PCT Filed: Jun. 1, 2023
(86) PCT No.: PCT/KR2023/007533

§ 371 Date: Jan. 19, 2024

(30) Foreign Application Priority Data
Jun. 3, 2022 (KR) 10-2022-0068357

(51) Int. Cl. B65G 47/91; B65G 57/04; H01M 8/2475; H01M 10/0585

(52) U.S. Cl. CPC B65G 47/918; B65G 57/04; H01M 8/2475; H01M 10/0585; B65G 2201/022

(57) ABSTRACT

A transfer device for transporting a cell laminate in which a plurality of electrodes and separators are stacked includes a base plate, a grasping unit, and a support unit. The base plate is capable of moving in a horizontal direction and capable of ascending and descending in a vertical direction at a certain point. The grasping unit is coupled to the lower part of the base plate and picks up the upper surface of the laminate. The support unit is coupled to the base plate and supports the lower part of the laminate picked up by the grasping unit. The support unit comprises: a vertical moving member, and a rotating member coupled to the vertical moving member and rotates about the coupling point to support the laminate.

### CROSS-REFERENCE TO RELATED APPLICATIONS

The present invention is a national phase entry under 35 U.S.C. § 371 of International Application No. PCT/KR2023/007533, filed on Jun. 1, 2023, which claims priority from Korean Patent Application No. 10-2022-0068357, filed on Jun. 3, 2022, all of which are incorporated herein by reference.

### TECHNICAL FIELD

The present disclosure relates to a transfer device, and more specifically, to a transfer device that transports a laminate in which multiple electrodes and separators are stacked by picking up the laminate, as well as a transfer method using the same.

### BACKGROUND ART

Generally, based on the shape of the battery case, battery cells are classified into cylindrical battery cells or prismatic battery cells in which an electrode assembly is housed in either a cylindrical or prismatic metal can, and a pouch-type battery cell in which an electrode assembly is housed in a pouch-type case made of aluminum laminate sheets. Among these, there is a particularly high interest in pouch-type battery cells due to their ease of shape modification and lightweight characteristics.

An electrode assembly housed in a battery case consists of a layered structure of positive electrode/separator/negative electrode, serving as a power generating element capable of charging and discharging. It can be classified into a jelly-roll type, where a long sheet-type positive electrode and negative electrode with active material coated on them are wound with a separator interposed therebetween, and a stack-type, where multiple positive electrodes and negative electrodes of a certain size are sequentially layered with separators interposed therebetween.

Moreover, to enhance the processability of conventional stack-type electrode assemblies and to meet the demand for battery cells of various shapes, development is underway for lamination/stack-type electrode assemblies that have a structure in which unit cells with electrodes and separators alternately layered and bonded are stacked.

Such an electrode assembly, due to its laminated structure of multiple electrodes and separators, is prone to issues like breaking of the laminated structure or tearing of the separators even from minor shakes or impacts during handling. Therefore, both sides of the electrode assembly are fixed with insulating tape or the like for storage.

Meanwhile, during the process of transporting the electrode assembly fixed with insulating tape or the like, it has been frequently observed that the electrodes or separators contained in the electrode assembly get damaged, leading to a poor battery cell quality.

FIG. 1 illustrates a conventional transfer device for transporting an electrode assembly. The conventional transfer device may comprise a base plate 1 that is movable in all xyz axis directions, and an grasping unit 2 coupled to the base plate 1 to pick up the surface of an electrode assembly by clinging to the surface (e.g., via vacuum suction).

FIG. 2 illustrates the process of transporting a laminate 3 in which multiple electrodes and separators are laminated, using the transfer device from FIG. 1. As shown in part (a) of FIG. 2, the laminate 3 has insulating tapes 4 attached to both sides to maintain and fix the laminated structure of the electrodes and separators. The base plate 1 that has moved to the upper part of the laminate 3 descends to pick up the upper surface of the laminate 3 with the grasping unit 2. It then lifts the laminate 3 upwards to transfer it to the desired location. However, as shown in part (b) of FIG. 2, a gap can occur between the grasped part directly picked up by the grasping unit 2 and the part not grasped due to the weight of the laminate 3. This process can result in tearing or damage to electrodes and separators.

Therefore, there is a need for a transfer device with a new structure that can suppress the tearing of electrodes and separators and prevent the degradation of the quality of secondary batteries.

### Technical Problem

The present technology was conceived to address the aforementioned problems, and is directed to solve the issue of quality degradation of a laminate being transferred through a transfer device.

Other objects and advantages of the present invention will become apparent through the detailed description provided below, and will be more clearly recognized by the exemplary embodiments of the present invention. Furthermore, it will be readily apparent that the objects and advantages of the present invention may be realized by the means and combinations thereof disclosed in the claims of the patent.

### Technical Solution

According to an aspect of the present invention, a transfer device that picks up and transports a laminate with a plurality of electrodes and separators includes: a base plate capable of moving in a horizontal direction, and capable of ascending and descending in a vertical direction at a certain point; a grasping unit coupled to the lower part of the base plate and picking up the upper surface of the laminate; and a support unit coupled to the base plate and supporting the lower part of the laminate picked up by the grasping unit, wherein the support unit includes: a vertical moving member, and a rotating member coupled to the vertical moving member and rotates about the coupling point to support the laminate.

The grasping unit may include an grasping pad attached to the upper surface of a laminate; and an grasping tube having both ends respectively coupled to the base plate and the grasping pad to fix the grasping pad to the base plate.

A plurality of grasping units may be coupled to the lower part of the base plate to pick up each corner of the laminate.

The support unit may include a fixing member coupled to both sides of the base plate and extending downward; a vertical moving member coupled to the fixing member to be slidable and move vertically up and down; and a rotating member coupled to the lower part of the vertical moving member.

The fixing member may include a vertical guide rail vertically extending on one side, the vertical moving member may be coupled to the fixing member to be guided by the vertical guide rail, and the vertical moving member may be guided by the vertical guide rail to move vertically up and down with respect to the fixing member.

The fixing member includes a linear motor, and the vertical moving member may be coupled to the linear motor to move vertically up and down.

The fixing member includes a pneumatic cylinder, and the vertical moving member may be coupled to the pneumatic cylinder and moves vertically up and down according to the movement of the piston of the pneumatic cylinder.

The support unit may be coupled to the base plate to be horizontally slidable with respect to the base plate.

The rotating member may be axially coupled to an end of the vertical moving member, and may rotate about the axis.

The rotating member extends horizontally with respect to the axis, and the lower part of a laminate clinging to the grasping unit may be supported by the rotating member rotating about the axis.

The rotating member may include a forwardly sloping inclined surface at the upper part.

The vertical moving member may include a servo motor at an end, and the rotating member may be coupled to the servo motor and rotates about a rotation axis formed in a vertical direction.

The vertical moving member may include a pneumatic motor at its end, and the rotating member may be coupled to the pneumatic motor and rotates about a rotation axis formed in a vertical direction.

At least two or more rotating members may be coupled to a lower part of the vertical moving member.

The base plate may be coupled to a driving device for moving the base plate in a vertical direction and a horizontal direction to one side.

According to an aspect of the present invention, a transfer method includes: preparing a laminate in which a plurality of electrodes and separators are stacked; preparing the transfer device according to an aspect of the present invention on the laminate; picking up the laminate by lowering the base plate; manipulating the support unit to support the lower part of the laminate; and lifting the base plate.

Manipulating the support unit may include: sliding the vertical moving member to the lower part; rotating the rotating member toward the laminate; and sliding the vertical moving member to the upper part.

### Advantageous Effects

According to an aspect of the present invention, the process efficiency of the secondary battery can be improved by preventing the tearing of electrodes and separators that can occur during the transfer of a laminate.

### BRIEF DESCRIPTION OF THE DRAWINGS

FIG. 1 illustrates a conventional transfer device.

FIG. 2 illustrates a process of transporting a laminate using the transfer device of FIG. 1.

FIG. 3 is a perspective view of a transfer device according to a first embodiment of the present invention.

FIG. 4 is a front view of the transfer device of FIG. 3.

FIG. 5 illustrates the operation of a support unit.

FIG. 6 illustrates a modified example of a support unit.

FIG. 7 illustrates the operation of the support unit in FIG. 6.

FIG. 8 illustrates a modified example of a rotating member.

FIG. 9 illustrates the process of a grasping and transportation of a laminate in stages.

FIG. 10 illustrates a support unit included in the transfer device according to a second embodiment of the present invention.

FIG. 11 illustrates an example of the operation of a support unit included in the transfer device according to a third embodiment of the present invention.

FIG. 12 illustrates another example of the operation of a support unit included in the transfer device according to a third embodiment of the present invention.

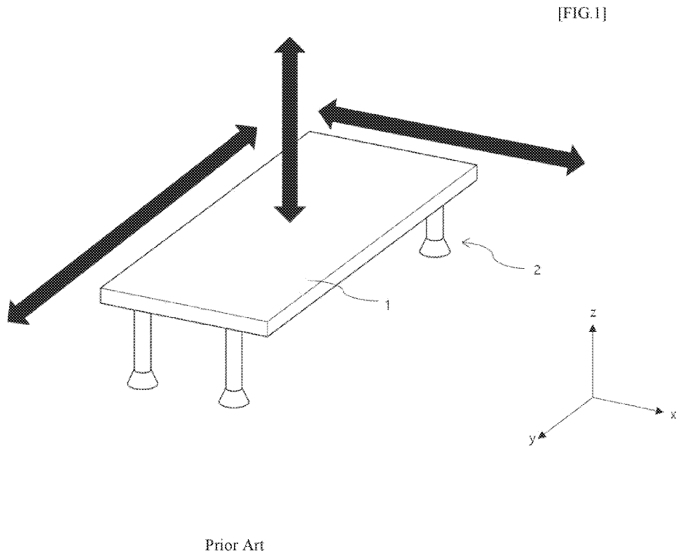

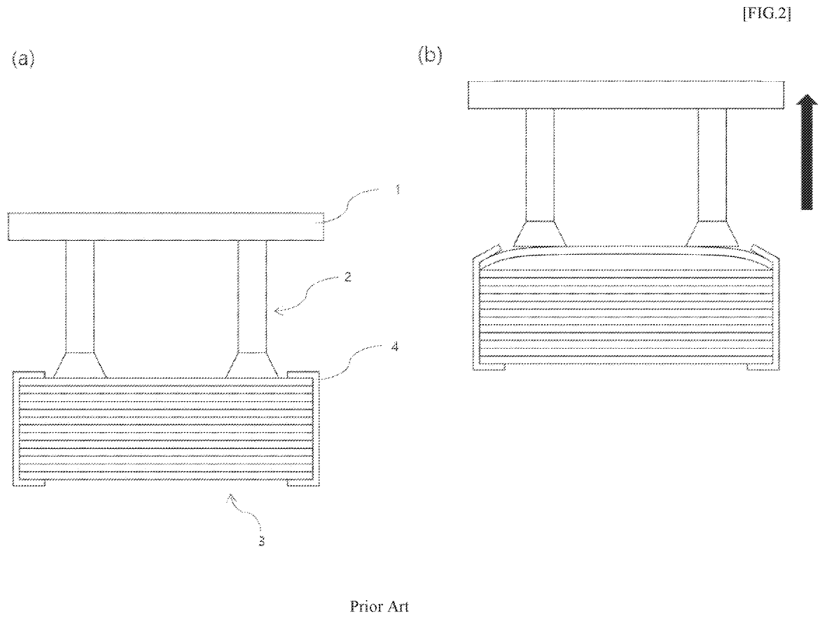

### DETAILED DESCRIPTION

Hereinafter, preferred embodiments of the present invention will be described in detail with reference to the accompanying drawings. Before doing so, it should be noted that the terms and words used in this specification and claims are not to be construed in their ordinary or dictionary sense, but rather in a sense and concept consistent with the technical idea of the present invention, based on the principle that the inventor may properly define the concept of a term to best describe his invention.

Accordingly, it is to be understood that the embodiments described herein and the configurations illustrated in the drawings are only the most preferred embodiments of the present invention and do not represent all of the technical ideas of the present invention, and that there may be various equivalents and modifications that may be substituted for them at the time of filing.

Additionally, when providing an explanation for the present invention, if a detailed description of related technical configurations or functions is deemed to potentially obscure the essence of the present invention, such a detailed description will be omitted.

The embodiments of the present technology are provided to offer a more comprehensive explanation to those skilled in the art, so the shapes, sizes, and other aspects of the components shown in the drawings can be exaggerated, omitted, or simplified for clarity. Therefore, the size or ratio of each component does not fully reflect its actual size or ratio.

An embodiment of the present invention relates to a transfer device, and more specifically, to a transfer device that picks up and transfers a laminate 10 in which a plurality of electrodes and separators are stacked.

The laminate 10 has a shape in which electrodes and separators are alternately stacked, and more specifically, the laminate 10 has a shape in which a plurality of negative electrodes and positive electrodes are alternately stacked with a separator interposed therebetween.

In addition, the laminate 10 of an embodiment of the present invention can have an insulating tape 11 attached to its side to fix the laminated structure.

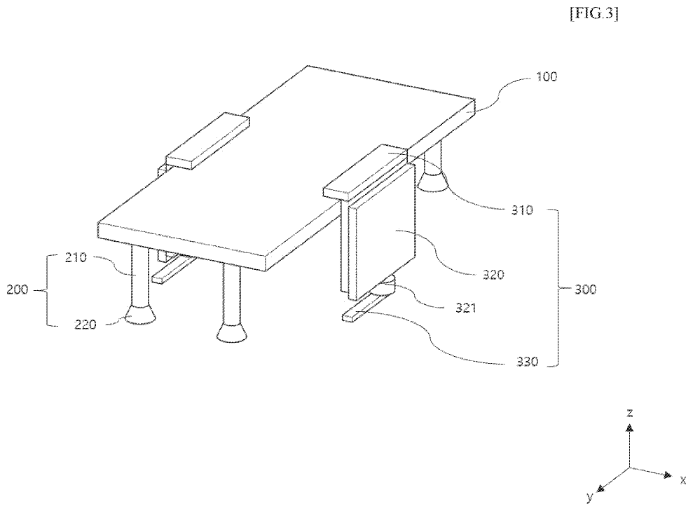

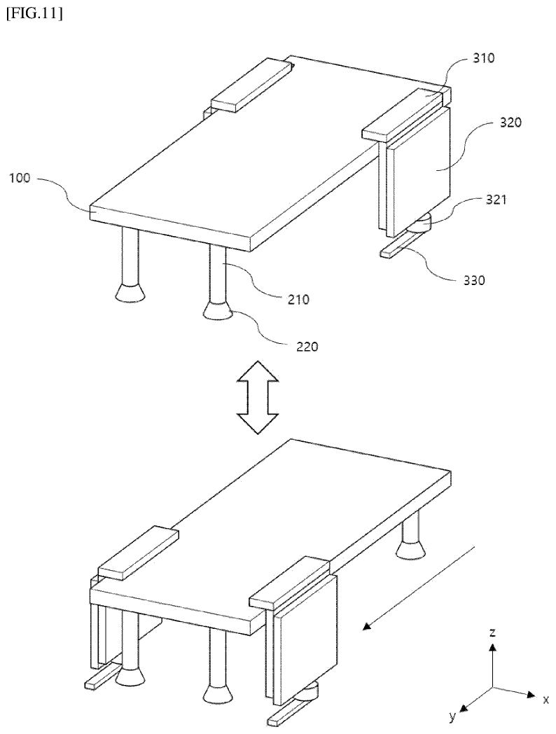

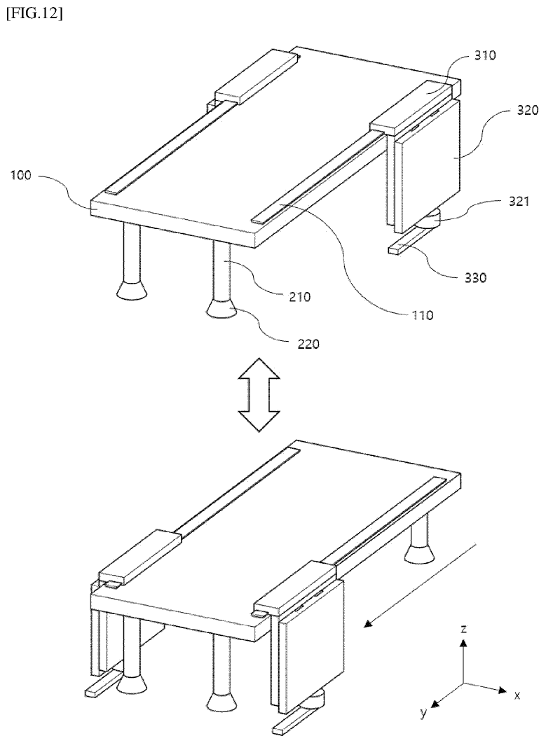

FIG. 3 through 9 relate to a transfer device according to the first embodiment of the present invention, FIG. 10 relates to a transfer device according to the second embodiment of the present invention, and FIG. 11 through 12 relate to a transfer device according to the third embodiment of the present invention.

Hereafter, the transfer devices according to each embodiment of the present invention will be described with reference to the drawings.

### First Embodiment

### Transfer Device

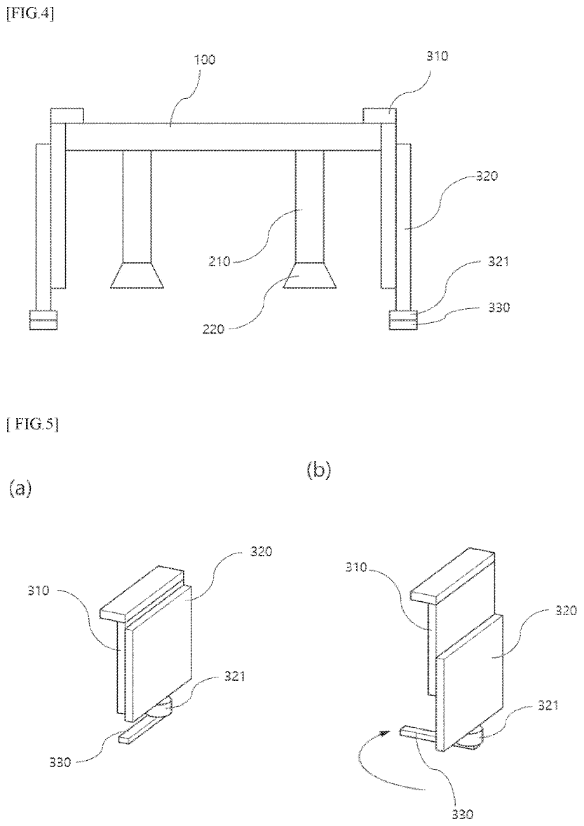

FIG. 3 is a perspective view of a transfer device according to the first embodiment of the present invention, and FIG. 4 is a front view of the transfer device in FIG. 3.

According to FIGS. 3 and 4, the transfer device of an embodiment of the present invention includes a base plate 100, a grasping unit 200, and a support unit 300.

The base plate 100 is installed to be freely movable in both horizontal and vertical directions so that it can transfer the laminate 10 to a specific area.

The base plate 100 can move in a horizontal direction, and can move up and down vertically at a certain point. Referring to FIG. 3, based on the xyz coordinate system, the base plate 100 can move in all xyz axes directions.

The base plate 100 is coupled with a separate driving device (not shown) on one side.

The driving device may be any device or means to move the base plate 100 in the vertical direction (z-axis direction) and the horizontal direction (xy-axis direction), and is not particularly limited by an embodiment of the present invention.

The grasping unit 200 serves to pick up the upper surface of the laminate 10 using clinging power (e.g., by vacuum suction).

The grasping unit 200, as shown in FIGS. 3 and 4, is coupled to the lower part of the base plate 100, and extends along the base plate 100.

The grasping unit 200 is composed of a grasping pad 220 and an grasping tube 210.

The grasping pad 220 directly contacts and attaches to the surface of the laminate 10. It is a typical suction or vacuum pad 220 and any material and shape that can deliver strong clinging power to the surface of the laminate 10 without damaging it can be used.

The grasping tube 210 serves as the connecting part between the grasping pad 220 and the base plate 100. Both ends of it are respectively connected to the base plate 100 and the grasping pad 220, and it has an elongated shape in the vertical direction.

The grasping tube 210 is of a hollow form containing a gas-moving passage (not shown) inside where gas moves, the gas-moving passage being connected to a vacuum source (not shown) which provides a suction force. Thus, by operation of the vacuum source, the grasping pad 220 in communication with the gas-moving passage picks up the surface of the laminate 10. At this time, the gas-moving passage and the vacuum source may be connected via a separate air hose (not shown).

The vacuum source can take the form of an air pump or any other device capable of providing suction power.

A plurality of grasping units 200 can be coupled to the base plate 100.

Since the upper surface of the laminate 10 of an embodiment of the present invention has a rectangular shape, it is desirable for at least four or more grasping units 200 to be coupled to the base plate 100. Each grasping unit 200 contacts each corner of the laminate 10 to pick it up.

The support unit 300 serves to support the lower part of the laminate 10 clinging to the grasping unit 200.

The support unit 300 is coupled to the base plate 100. More specifically, as shown in FIGS. 3 and 4, the support unit 300 is respectively coupled to both sides of the base plate 100.

The support unit 300 is composed of a fixing member 310, a vertical moving member 320, and a rotating member 330.

The fixing member 310 is a part directly coupled to the base plate 100, which may be coupled to at least one of the upper and side parts of the base plate 100, and may be coupled to both the upper and side parts and extend downwardly as shown.

The fixing member 310 does not move up or down relative to the base plate 100, and serves to support and guide the vertical moving member 320.

The vertical moving member 320 is characterized in that it is guided by the fixing member 310 to be lifted up and down.

The vertical moving member 320 is slidably coupled to the fixing member 310 to move up and down.

The vertical moving member 320 may be moved up and down by a driving device, such as a linear motor or a pneumatic cylinder.

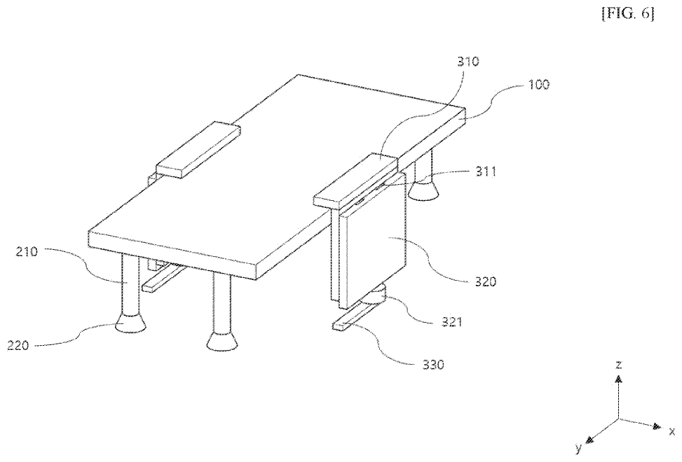

FIG. 5 illustrates the operation of a support unit 300.

According to FIG. 5, the fixing member 310 includes a pneumatic cylinder (not shown), and the vertical moving member 320 is coupled to said pneumatic cylinder and rises up and down according to the movement of a piston (not shown) of the pneumatic cylinder. That is, the vertical moving member 320 is coupled to a piston of the pneumatic cylinder and rises according to the movement of the piston.

It is sufficient that the pneumatic cylinder is of a structure capable of transmitting the pressure of incoming air to a piston to reciprocate the piston and the vertical moving member 320 connected to the piston in a straight path.

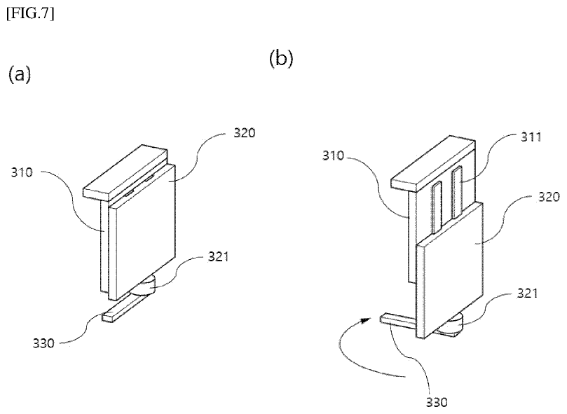

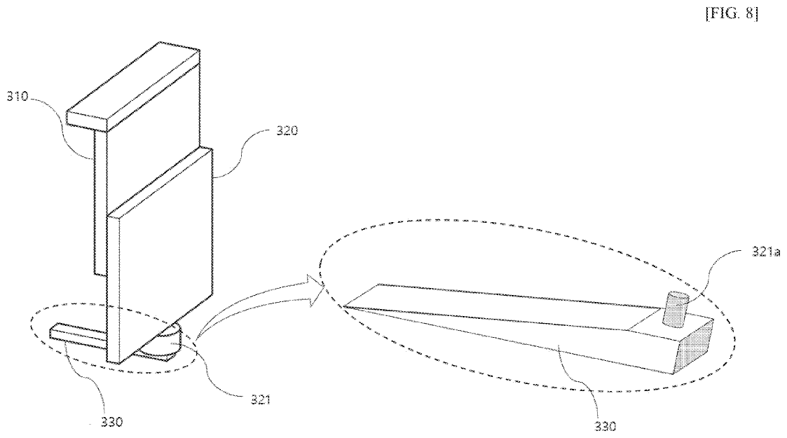

FIGS. 6 and 7 illustrate modified examples of a support unit 300.

According to FIGS. 6 and 7, the fixing member 310 includes a linear motor (not shown), and the vertical moving member 320 is coupled to the linear motor and moves up and down based on the operation of the linear motor. In this case, the fixing member 310 includes a vertical guide rail 311 formed to extend in a vertical direction to guide the movement of the vertical moving member 320, and the vertical moving member 320 is guided by the vertical guide rail 311 to move up and down.

The linear motor may include a mover (not shown) that is reciprocally moved along a vertical guide rail 311 having a straight path by supplied electricity, and the vertical moving member 320 is coupled to the mover and moves up and down with the movement of the mover.

It is sufficient for the linear motor to be of a structure capable of moving the mover and the vertical moving member 320 reciprocally in a straight path by means of supplied electricity.

The rotating member 330 is coupled with the vertical moving member 320 as shown in FIGS. 3 to 5, and is raised up and down in accordance with the movement of the vertical moving member 320, and is characterized in that it rotates about its coupling site with the vertical moving member 320.

The rotating member 330 is axially coupled to an end of the vertical moving member 320, and rotates about the coupled axis.

The rotating member 330 may be elongated in a horizontal direction about the coupled axis, and an elongated part of the rotating member 330 may rotate about the axis, wherein a lower part of a laminate 10 may be supported by the rotation of the rotating member 330.

The rotating member 330 may also include an inclined surface.

FIG. 8 illustrates a modified example of a rotating member 330 included in the support unit 300. As shown in FIG. 8, the rotating member 330 includes a forwardly sloping inclined surface at the upper part.

The vertical moving member 320 includes a rotational driving device 321, such as a servo motor or a pneumatic motor, at its end, and the rotating member 330 is coupled to the rotational driving device 321.

Specifically, the vertical moving member 320 may include a servo motor at its end, and the rotating member 330 is coupled with a rotation axis 321a formed in a vertical direction included in the servo motor. The rotation driving device 321 can be rotated by electricity supplied to the servo motor, and the rotating member 330 coupled with the rotation driving device 321 rotates about the rotation axis 321a by rotation of the rotation driving device 321.

In addition, the vertical moving member 320 can also include a pneumatic motor at its end, and the rotating member 330 is coupled to a rotation driving device 321 formed vertically within the pneumatic motor. The rotation driving device 321 can rotate due to the pressure of the air supplied to the pneumatic motor, and the rotating member 330 coupled to the rotation driving device 321 rotates about the rotation axis 321a by rotation of the rotation driving device 321.

### Transfer Method

The transfer method of an embodiment of the present invention is characterized by utilizing a transfer device of an embodiment of the present invention, which includes a base plate 100, a grasping unit 200, and a support unit 300.

The transfer method of an embodiment of the present invention includes preparing a laminate 10, preparing the transfer device, clinging to the laminate, supporting, and lifting.

The preparing a laminate 10 involves preparing a laminate 10 in which a plurality of electrodes and separators are stacked.

The preparing the transfer device involves preparing the transfer device of an embodiment of the present invention to receive the prepared laminate 10.

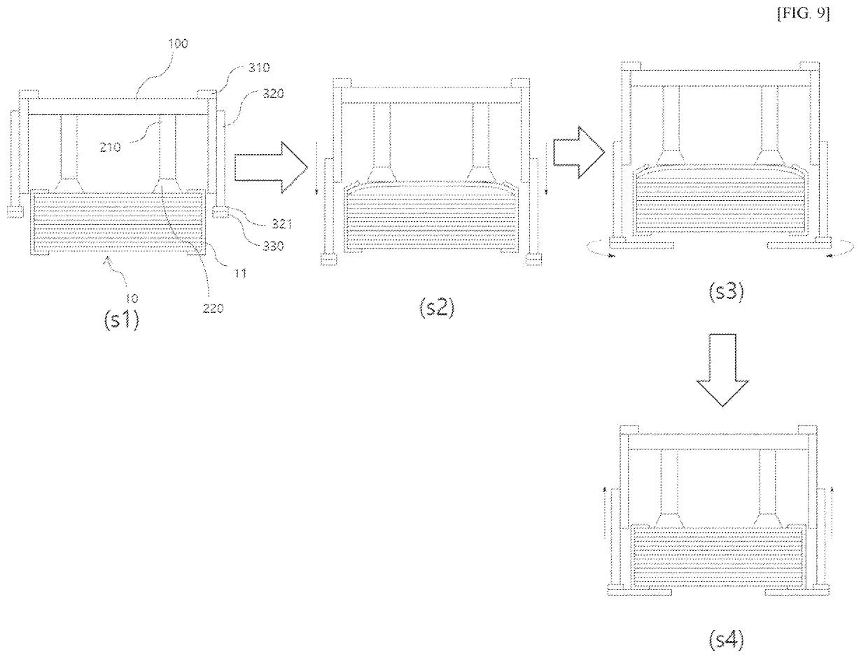

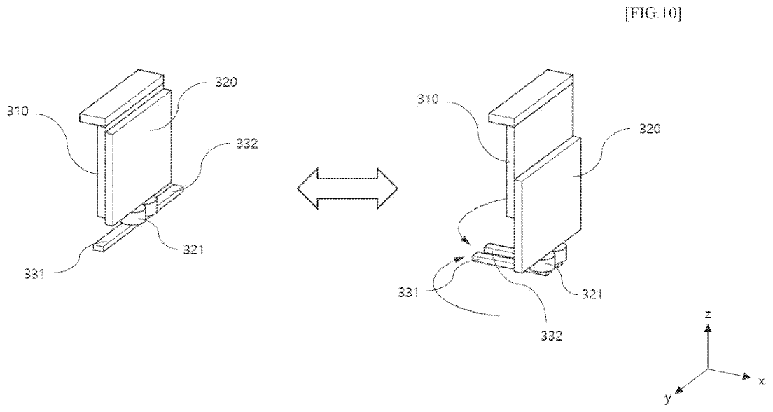

FIG. 9 is a step-by-step illustration of the process of picking up and transporting the laminate 10 by the transfer device. That is, FIG. 9 specifically illustrates the picking up the laminate, s1, and the supporting s2, s3, s4.

The picking up of the laminate s1 is a step of lowering the base plate 100 to grasp the laminate 10.

Specifically, the base plate 100 is lowered to a height at which the grasping pad 220 is in full contact with the upper surface of the laminate 10, as shown in FIG. 9. At this time, a rotating member 330 coupled to the lower part of the vertical moving member 320 is kept level with the vertical moving member 320 in the y-axis direction as the vertical moving member 320 descends, so as not to contact the upper part of the laminate 10.

After the movement of the base plate 100 is completed, the grasping unit 200 suctions and clings to the upper surface of the laminate 10.

The supporting steps s2, s3, s4 are steps to support the lower part of the laminate 10 by manipulating the support unit 300.

The supporting may be divided into a sliding the vertical moving member 320 to the lower position, s2, a rotating the rotating member 330 s3, and a sliding the vertical moving member 320 to the upper position, s4.

The sliding the vertical moving member 320 to the lower position s2 is a step to slide the vertical moving member 320 to the lower part.

The base plate 100 descends until the grasping unit 200 clings to the laminate 10, and at the same time, the vertical moving member 320 descends on the fixing member 310. At this time, the vertical moving member 320 descends until the rotating member 330 is positioned near the lower part of the laminate 10.

The rotating, s3, is a step of rotating the rotating member 330 towards the laminate 10.

The rotating member 330 is rotated toward the laminate 10 by operation of the rotational driving device 321. At this time, the rotating members 330 rotated on both sides of the base plate 100 are symmetrical to each other, and remain rotated toward the laminate 10.

The sliding the vertical moving member 320 to the upper position, s4, is a step of slidingly moving the vertical moving member 320 to the upper part.

The vertical moving member 320 rises on the fixing member 310, and the rotating member 330 located at the lower part of the laminate 10 rises with the rise of the vertical moving member 320 to support the lower part of the laminate 10.

The lifting is a step of lifting the base plate 100.

The base plate 100 is lifted to the upper part to transport the laminate 10 to another area while the grasping unit 200 grasps the laminate 10 and the support unit 300 supports the grasped laminate 10.

By going through the same process as above, the transfer device is able to safely transport the laminate 10 supported by the rotating member 330 to a place of destination.

### Second Embodiment

The transfer device according to the second embodiment of the present invention is characterized in that, at least two or more rotating members 330 are coupled to the lower part of the vertical moving member 320 in the transfer device according to the first embodiment.

FIG. 10 shows a support unit 300 included in a transfer device according to a second embodiment of the invention.

A pair of rotating members 330 are coupled to the lower part of the vertical moving member 320, as shown in FIG. 10. Specifically, the vertical moving member 320 includes a pair of rotational driving devices 321 at its lower end, and a rotation axis 321a of each of the rotational driving devices 321 allows for rotation in different directions. The rotating member 330 includes a main rotating member 331 coupled to one of the pair of rotational driving devices 321 and a sub-rotating member 332 coupled to the other.

The main rotating member 331 and sub-rotating member 332 are respectively level with the vertical moving member 320 with respect to the y-axis direction when the grasping unit 200 has not picked up the laminate 10. Subsequently, when the grasping unit 200 picks up the laminate 10, and the vertical moving member 320 is lowered to a suitable position, the main rotating member 331 and the sub-rotating member 332 rotate in different directions.

The rotational driving device 321 may be installed at a predetermined spacing in the y-axis direction at the lower part of the vertical moving member 320 differently from that shown in FIG. 10, and the main rotating member 331 and sub-rotating member 332 may each support the lower part of one side of the laminate 10 by being spaced apart in a predetermined distance.

### Third Embodiment

The transfer device according to the third embodiment of the present invention is characterized in that, the support unit 300 is coupled to the base plate 100 in the transfer device according to the first embodiment to be able to slide with respect to the base plate 100.

Specifically, the base plate 100 includes pneumatic cylinders or linear motors on both sides, and a fixing member 310 included in the support unit 300 is coupled to the pneumatic cylinders or linear motors and slides according to the operation of the pneumatic cylinders or linear motors.

FIGS. 11 and 12 illustrate the operation of a support unit 300 included in a transfer device according to a third embodiment of the present invention.

FIG. 11 illustrates an example of the operation of a support unit 300 in sliding movement in the y-axis direction on a base plate 100.

According to FIG. 11, the fixing member 310 is coupled to a pneumatic cylinder and slidingly reciprocates according to a piston (not shown) movement of the pneumatic cylinder. In this case, the pneumatic cylinder may utilize any structure capable of transmitting the pressure of incoming air to the piston to cause the piston and the fixing member 310 connected to the piston to reciprocate in a straight path.

FIG. 12 illustrates another example of the operation of a support unit 300 in sliding movement in the y-axis direction on a base plate 100.

According to FIG. 12, the fixing member 310 is slidingly reciprocated according to the operation of a linear motor. In this case, both sides of the base plate 100 include horizontal guide rails 110 formed in a horizontal direction to guide the movement of the fixing member 310, and the fixing member 310 slides by being guided by the horizontal guide rails 110.

The linear motor may include a mover (not shown) that is reciprocally moved along the horizontal guide rail 110 having a straight path by supplied electricity, and the fixing member 310 is coupled to the mover and slidingly moves in accordance with the movement of the mover.

The linear motor may utilize any structure capable of causing the mover and fixing member 310 to reciprocate in a straight path by means of supplied electricity.

The present invention has been described in more detail above with reference to the drawings and embodiments. However, it is to be understood that the configurations shown in the drawings or embodiments described herein are only one embodiment of the invention and do not represent all of the technical ideas of the invention, and that there may be various equivalents and modifications that may replace them at the time of filing the present application.

### REFERENCE NUMERALS

1: (PRIOR ART) BASE PLATE
2: (PRIOR ART) GRASPING UNIT
3: (PRIOR ART) LAMINATE
4: (PRIOR ART) INSULATION TAPE
10: LAMINATE
11: INSULATION TAPE
100: BASE PLATE
110: HORIZONTAL GUIDE RAIL
200: GRASPING UNIT
210: GRASPING TUBE
220: GRASPING PAD
300: SUPPORT UNIT
310: FIXING MEMBER
311: VERTICAL GUIDE RAIL
320: VERTICAL MOVING MEMBER
321: ROTATIONAL DRIVING DEVICE
321a: ROTATION AXIS
330: ROTATING MEMBER
331: MAIN ROTATING MEMBER
332: SUB-ROTATING MEMBER

1. A transfer device that picks up and transports a laminate with a plurality of electrodes and separators, the transfer device comprising:
a base plate configured to move in a horizontal direction and a vertical direction, wherein the base plate is configured to ascend and descend in the vertical direction;
a grasping unit coupled to a lower part of the base plate and configured to pick up an upper surface of the laminate; and
a support unit coupled to the base plate and configured to support a lower part of the laminate, wherein
the support unit comprises:
a vertical moving member, and
a rotating member coupled to the vertical moving member and configured to rotate about a coupling point to support the laminate.

2. The transfer device of claim 1, wherein
the grasping unit comprises:
an grasping pad configured to attach to the upper surface of the laminate; and
an grasping tube having both ends coupled to the base plate and the grasping pad, respectively, so as to fix the grasping pad to the base plate.

3. The transfer device of claim 1, wherein
a plurality of grasping units are coupled to the lower part of the base plate and configured to pick up each corner of the upper surface of the laminate.

4. The transfer device of claim 1, wherein
the support unit comprises:
a fixing member coupled to opposing sides of the base plate and extending downward;
the vertical moving member coupled to the fixing member and configured to be slidable along the vertical direction; and
the rotating member coupled to a lower part of the vertical moving member.

5. The transfer device of claim 4, wherein
the fixing member comprises a vertical guide rail extending vertically along a side of the fixing member;
the vertical moving member is coupled to the fixing member so as to be guided by the vertical guide rail; and
the vertical moving member is configured to be guided by the vertical guide rail so as to move in the vertical direction with respect to the fixing member.

6. The transfer device of claim 5, wherein
the fixing member comprises a linear motor, and
the vertical moving member is coupled to the linear motor and configured to move in the vertical direction.

7. The transfer device of claim 4, wherein
the fixing member comprises a pneumatic cylinder, and
the vertical moving member is coupled to the pneumatic cylinder and configured to move in the vertical direction according to a movement of a piston of the pneumatic cylinder.

8. The transfer device of claim 1, wherein
the support unit is coupled to the base plate and is configured to be slidable along the base plate in the horizontal direction.

9. The transfer device of claim 4, wherein
the rotating member is axially coupled to an end of the vertical moving member, and includes a rotation axis extending in the vertical direction, about which the rotating member is configured to rotate.

10. The transfer device of claim 9, wherein
the rotating member extends horizontally with respect to the rotation axis, and
the lower part of the laminate is supported by the rotating member.

11. The transfer device of claim 9, wherein
the rotating member comprises an inclined surface extending from the rotation axis towards a center of the laminate.

12. The transfer device of claim 9, wherein
the vertical moving member comprises a servo motor at the end, and
the rotating member is coupled to the servo motor and configured to rotate about the rotation axis.

13. The transfer device of claim 9, wherein
the vertical moving member comprises a pneumatic motor at the end, and
the rotating member is coupled to the pneumatic motor and configured to rotate about the rotation axis.

14. The transfer device of claim 1, wherein
a plurality of rotating members are coupled to a lower part of the vertical moving member.

15. The transfer device of claim 1, wherein
the base plate is coupled to a driving device configured to move the base plate in the vertical direction and the horizontal direction.

16. A transfer method comprising:
preparing the laminate in which the plurality of electrodes and separators are stacked;
preparing the transfer device of claim 1 to receive the laminate;
grasping the laminate by lowering the base plate;
manipulating the support unit to support the lower part of the laminate; and
lifting the base plate.

17. The transfer method of claim 16, wherein
manipulating the support unit comprises:
sliding the vertical moving member to a lower part of the fixing member;
rotating the rotating member toward the laminate; and
sliding the vertical moving member to an upper part of the fixing member.
